(19) United States
(12) Patent Application Publication
(10) Pub. No.: US 2008/0231252 A1
(43) Pub. Date: Sep. 25, 2008

(54) Sag-Swell and Outage Generator for Performance Test of Custom Power Devices

(76) Inventors: Euicheol Nho, Busan (KR); Sangsuk Lee, Gyeonggi-do (KR)

Correspondence Address: LAHIVE & COCKFIELD, LLP;FLOOR 30, SUITE 3000, ONE POST OFFICE SQUARE, BOSTON, MA, 02109, US

(21) Appl. No.: 10/586,464

(22) PCT Filed: Jan. 14, 2004
(86) PCT No.: PCT/KR04/00056

§ 371 Date: Jul. 14, 2006

(51) Int. Cl. G05B 24/00

(52) U.S. Cl. 323/350

(57) ABSTRACT

The present invention relates to a sag-swell generator for generating power signal with sag, swell and outage for use in testing custom power devices.

The sag-swell generator comprises: a supply voltage unit for providing a supply voltage; a variable voltage adjusting unit for controlling the supply voltage according to a voltage ratio; a variable voltage-side switch unit selectively connected to the variable voltage adjusting unit; a transformer-side switch unit composed of dual switches connected anti-parallel to each other; and a transformer, a primary side of which being connected to the transformer-side switch unit and a secondary side of which being serially connected to a load and a (−) terminal of the supply voltage.

### TECHNICAL FIELD

The present invention relates to a voltage variation generator for performance test of custom power devices. More particularly, the present invention relates to a small/light-weight voltage variation generator with a simple structure, which employs an SCR (Silicon Controlled Rectifier) thyristor and can effectively generate voltage variation such as voltage sag, voltage swell and instant outage in order to test performance of various customer power devices such as Uninterruptible Power Supplys (Hereinafter, referred to as UPSs), Dynamic Voltage Restorers (Hereinafter, referred to as DVRs), Distribution Static Compensators (Hereinafter, referred to as DSTATCOMS), Static Var Compensators (Hereinafter, referred to as SVCs), and Solid State Transfer Switches (Hereinafter, referred to as SSTSs).

### BACKGROUND ART

With the rapid development of electrical, electronic and information communication technology, many information communication systems such as computers, switching systems, transmission apparatus, cell enhancers and servers have been combined with each other more closely and organically. However, the information communication systems as described above should be supplied with stable power in order to operate stable. That is, apparatus requiring a high level of digital information processing, such as up-to-date industrial apparatus, medical apparatus, computers, various financial apparatus, office automation apparatus, precision control devices and information communication apparatus, are sensitively affected by voltage variation such as voltage sag, voltage swell, instant outage, overvoltage, low voltage and voltage unbalance in utility power.

The various undesired voltage variations as described above may deteriorate power quality. Therefore, a serious problem including abnormal operations, operation stoppages or malfunctions of various electronic apparatus may occur. For example, in the case of a video tape recorder (Hereinafter, referred to as VTR), when supply voltage is dropped by 15% during one several hundredth second, an internal memory circuit of the VTR may lose data therein. Further, a personal computer, a high-pressure discharge lamp, etc., may show abnormal operation to deviation of only 10˜30% of normal supply voltage.

Further, it is estimated that annual social and economical damage due to the deterioration of the power quality as described above amounts to 270˜650 billion Won in South Korea. According to a report (EPRI, 1993) of USA, it is estimated that the annual damage amounts to $ 26 billion. Furthermore, with the expansion of information communication industry, it is expected that the damage as described above will continue to increase. In light of this, various methods for improving power quality have been proposed and used.

In order to cope with the instant outage and voltage variation, among them, an uninterruptible power supply (UPS) has been used, which is a device capable of preventing abnormality of power due to voltage variation, frequency variation, instant outage or overvoltage and supplying continuous and stable power. Further, with the recent increased interest about custom power devices, which are high voltage/high current power control apparatus, research for custom power devices have been actively pursued, which include Dynamic Voltage Restorers (DVRs), Distribution Static Compensators (DSTATCOMs), Static Var Compensators (SVCs), Solid State Transfer Switches (SSTSs), etc.

However, in order to evaluate performance of the custom power devices, it is necessary to provide a device capable of generating various voltage variations such as voltage sag, voltage swell, instant outage, overvoltage, low voltage and voltage unbalance. Herein, the conventional devices have not been widely used because they are very expensive. Further, a scheme has been recently proposed, which uses a Thyristor Controlled Reactor (Hereinafter, referred to as TCR) with a low price. However, since the TCR has a disadvantage in that it excessively requires effective power, the feasibility of the TCR is questionable.

### DISCLOSURE OF THE INVENTION

Therefore, the present invention has been made in view of the above-mentioned problems, and it is an object of the present invention to provide a small/light-weight voltage variation generator with a simple structure, which employs an SCR thyristor and can effectively generate voltage variation such as voltage sag, voltage swell and instant outage in order to test performance of various customer power devices such as UPSs, DVRS, DSTATCOMs, SVCs and SSTSs.

According to one aspect of the present invention, there is provided a voltage variation generator for generating load voltage of voltage sag, voltage swell and instant outage for performance test of custom power devices, the voltage variation generator comprising: a supply voltage unit for applying AC supply voltage Vₛ, a positive output terminal of the supply voltage unit being connected in series to a load; a variable voltage adjuster connected to the positive output terminal of the supply voltage unit, for obtaining first voltage from the supply voltage according to a first transformation ratio; a variable voltage-side switch including two switching devices connected in reverse-parallel to each other, for selectively contacting in series with a primary side coil (interval I) or a secondary side coil (interval II) of the variable voltage adjuster and adjusting a contact point position with the variable voltage adjuster; a transformer-side switch including two switching devices connected in series to the variable voltage-side switch, said two switching devices being connected in parallel to each other in a reverse direction; and a transformer including a primary side and a secondary side, for obtaining second voltage from the first voltage according to a second transformation ratio, the primary side being connected in parallel to the transformer-side switch, the secondary side being connected in series to a negative output terminal of the supply voltage unit and the load respectively.

In the voltage variation generator, the switching device selectively uses an SCR thyristor, an IGBT and an IGCT.

### BRIEF DESCRIPTION OF THE DRAWINGS

The foregoing and other objects, features and advantages of the present invention will become more apparent from the following detailed description when taken in conjunction with the accompanying drawings in which.

FIG. 1 is a circuit diagram showing a 3-phase voltage variation generator according to an embodiment of the present invention;

FIG. 2 is a circuit diagram showing a single phase voltage variation generator when load voltage is in a normal state according to an embodiment of the present invention;

FIG. 3 is a circuit diagram showing a single phase voltage variation generator when load voltage is in a voltage sag state according to an embodiment of the present invention;

FIG. 4 is a circuit diagram showing a single phase voltage variation generator when load voltage is in an instant outage state according to an embodiment of the present invention; and

FIG. 5 is a circuit diagram showing a single phase voltage variation generator when load voltage is in a voltage swell state according to an embodiment of the present invention.

### BEST MODE FOR CARRYING OUT THE INVENTION

Reference will now be made in detail to the preferred embodiment of the present invention. The same reference numerals are used to designate the same elements as those shown in other drawings. In the following description of the present invention, a detailed description of known configurations and functions incorporated herein will be omitted when it may make the subject matter of the present invention rather unclear.

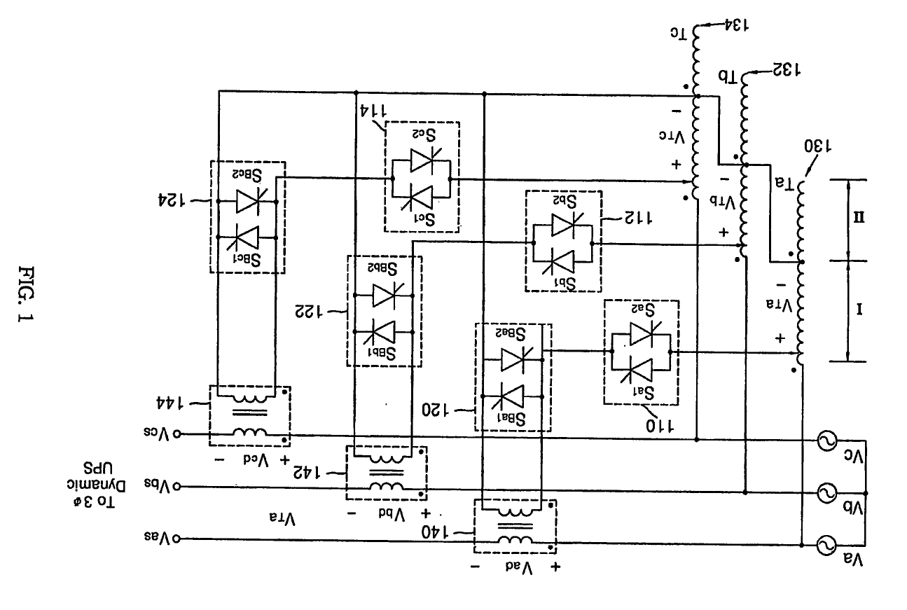

FIG. 1 is a circuit diagram showing a 3-phase voltage variation generator 100 according to an embodiment of the present invention.

First, the 3-phase voltage variation generator 100 according to the embodiment of the present invention generates voltage variation such as voltage sag, voltage swell, instant outage, voltage unbalance, overvoltage and low voltage. In order to generate the voltage variation as described above, the 3-phase voltage variation generator 100 includes variable voltage-side switches 110, 112 and 114 and transformer-side switches 120, 122 and 124. In each of the variable voltage-side switches 110, 112 and 114, two SCR thyristors have current flows in opposite directions and are connected in parallel to each other. The transformer-side switch 120 is connected in series to the variable voltage-side switch 110, the transformer-side switch 122 is connected in series to the variable voltage-side switch 112, and the transformer-side switch 124 is connected in series to the variable voltage-side switch 114. Further, similarly to the case of each of the variable voltage-side switches 110, 112 and 114, in each of the transformer-side switches 120, 122 and 124, two SCR thyristors have current flows in opposite directions and are connected in parallel to each other.

Further, the variable voltage-side switch 110 is connected in series to a variable voltage adjuster 130 connected to a supply voltage Vₐ. The variable voltage-side switch 112 is connected in series to a variable voltage adjuster 132 connected to a supply voltage V_{b}. The variable voltage-side switch 114 is connected in series to a variable voltage adjuster 134 connected to a supply voltage V_{c}. Further, the transformer-side switch 120 is connected in series to a transformer 140 connected in series to the supply voltage Vₐ. The transformer-side switch 122 is connected in series to a transformer 142 connected in series to the supply voltage V_{b}. The transformer-side switch 124 is connected in series to a transformer 144 connected in series to the supply voltage V_{c}. Herein, a slidacs, which is a kind of autotransformer, may be used as each of the variable voltage adjusters 130, 132 or 134. Each of the variable voltage-side switches 110, 112 and 114 may be selectively connected to an interval I or an interval II of each of the variable voltage adjusters 130, 132 and 134.

Further, the transformer 140 has voltage V_{ad}, the transformer 142 has voltage V_{bd}, and the transformer 144 has voltage V_{cd}. In addition, load voltage Vₐₛ having voltage variation generates in a primary side of the transformer 140, load voltage V_{bs} having voltage variation generates in a primary side of the transformer 142, and load voltage V_{cs} having voltage variation generates in a primary side of the transformer 144. Herein, each of the load voltage Vₐₛ, V_{bs} and V_{cs} is inputted to a 3-phase dynamic UPS.

Accordingly, voltage variation such as voltage swell, voltage sag and instant outage occurs according to contact point positions between the variable voltage adjusters 130 and the variable voltage-side switch 110, the variable voltage adjusters 132 and the variable voltage-side switch 112, and the variable voltage adjusters 134 and the variable voltage-side switch 114. Further, it is possible to control the range of the voltage variation by adjusting the contact point positions.

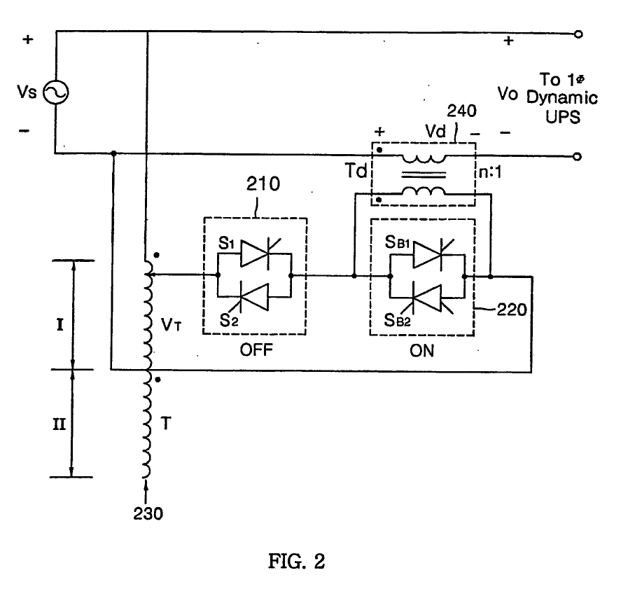

FIG. 2 is a circuit diagram showing a single phase voltage variation generator 200 when load voltage is in a normal state according to an embodiment of the present invention.

The single phase voltage variation generator 200 shown in FIG. 2 has a structure similar to that of the 3-phase voltage variation generator 100 described in FIG. 1. That is, the 3-phase voltage variation generator 100 or the single phase voltage variation generator 200 is selectively used according to whether the dynamic UPS to which load voltage of a voltage variation generator is applied is a 3-phase supply or a single phase supply. Since the 3-phase voltage variation generator 100 shown in FIG. 1 has the same operation principle as that of the single phase voltage variation generator 200 shown in FIG. 2, the operation principle of the single phase voltage variation generator 200 will be described for convenience of description.

The single phase voltage variation generator 200 has a circuit construction similar to that of the 3-phase voltage variation generator 100 shown in FIG. 1. That is, the single phase voltage variation generator 200 includes a supply voltage Vₛ, load voltage Vₒ applied to a single dynamic UPS, a variable voltage-side switch 210, a transformer-side switch 220, a variable voltage adjuster 230, a transformer 240, etc. Further, in FIG. 2, an interval I of the variable voltage adjuster 230 is a primary side or an interval II is a secondary side. Hereinafter, on/off states of the variable voltage-side switch 210 and the transformer-side switch 220, and a voltage variation state of load voltage according to contact point positions of the variable voltage-side switch 210 and the variable voltage adjuster 230 will be in detail described.

In FIG. 2, a relation of the supply voltage Vₛ, the voltage V_{d} of the transformer 240 and the load voltage Vₒ is expressed by equation 1.

Vₒ=Vₛ+V_{d} Equation 1

In equation 1, V_{d}=VT/n and VT=Vₛ/nT. Herein, the VT is voltage of the variable voltage adjuster 230 and the nT is a transformation ratio of the variable voltage adjuster 230. Further, the turn ratio of a primary side and the secondary side of the transformer 240 is n:1.

In a normal state, the voltage V_{d}=0 and thus the load voltage Vₒ is equal to the supply voltage Vₛ. Accordingly, in order to maintain the normal state, the variable voltage-side switch 210 is turned off and the transformer-side switch 220 is turned on. Herein, turning on or off the variable voltage-side switch 210 or the transformer-side switch 220 means turning on or off the S1 and the S2 or the SB1 and the SB2, respectively.

When the variable voltage-side switch 210 is turned off and the transformer-side switch 220 is turned on, the primary side and the secondary side of the transformer 240 are short-circuited. Therefore, the secondary side voltage V_{d} of the transformer 240 is 0. Accordingly, since the supply voltage Vₛ is equal to the load voltage Vₒ, the normal state is maintained. In such a case, since the transformer 240 is short-circuited, a contact point may be formed at any position.

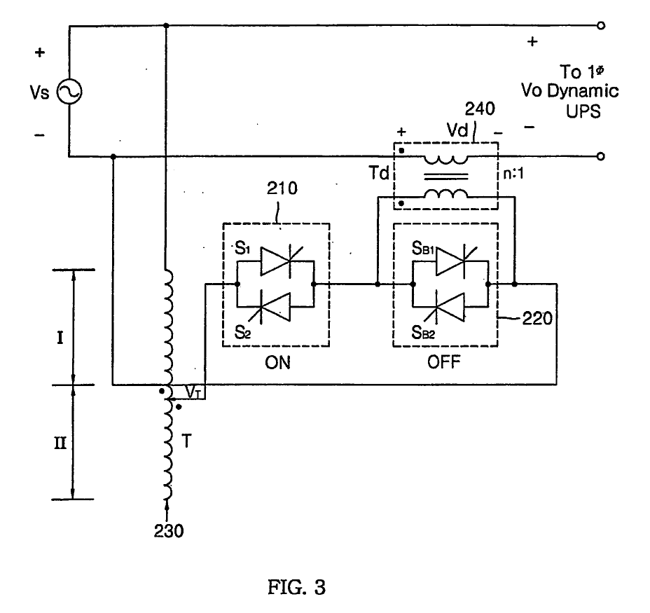

FIG. 3 is a circuit diagram showing the single phase voltage variation generator 200 when the load voltage is in a voltage sag state according to an embodiment of the present invention.

In order to change the state of the load voltage from a normal state to a voltage sag state, the transformer-side switch 220 is turned off and the variable voltage-side switch 210 is turned on. Therefore, the secondary side voltage VT of the variable voltage adjuster 230 is applied to the primary side of the transformer 240. Herein, In order to come into the voltage sag state, the polarity of the voltage V_{d} must be negative when considering equation 1 and the fact that the primary side of the transformer 240 and the secondary side of the transformer 240 have the same polarity. Accordingly, since the polarity of the voltage VT applied to the primary side of the transformer 240 must be negative, the voltage VT must be obtained from the interval II of the variable voltage adjuster 230. In such a case, the load voltage is calculated by equation 2.

$${V}_{o} = {V}_{s} ( 1 - \frac{1}{n \cdot {n}_{T}} ) \qquad Equation 2$$

In relation to equation 2, in the transformer 240, VT:V_{d}=n:1 and V_{d}=VT/n and VT=Vₛ/nT. When the V_{d} is put into equation 1, V_{d}=Vₛ(1+1/n·nT). Herein, since the variable voltage-side switch 210 is connected to the interval II of the variable voltage adjuster 230, the polarity of the voltage V_{d} is negative. Accordingly, equation 2 is obtained.

In equation 2, one can see that the degree of the voltage sag in the load voltage is determined by the transformation ratio n of the transformer 240 and the transformation ratio nT of the variable voltage adjuster 230. Further, the voltage VT can be easily obtained even in any point within the interval I or the interval II in a structure of a slidacs used as the variable voltage adjuster 230, so that it is possible to adjust the degree of the voltage sag by changing the contact point position. In FIG. 3, as the contact point position moves to a lower portion of the interval II, the voltage VT increases. Therefore, the degree of the voltage sag increases.

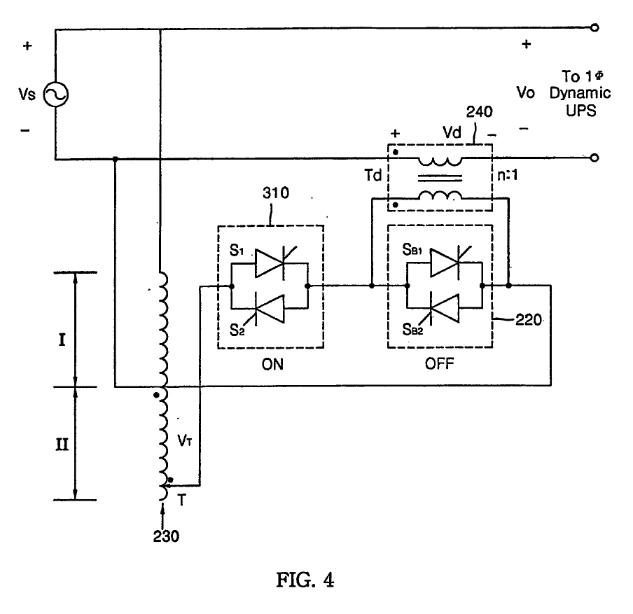

FIG. 4 is a circuit diagram showing the single phase voltage variation generator 200 when the load voltage is in an instant outage state according to an embodiment of the present invention.

The instant outage state occurs when the variable voltage-side switch 210 is turned on, the transformer-side switch 220 is turned off. In addition, the instant outage state occurs in a state similar to the voltage sag state having the contact point position in the interval II. That is, as described FIG. 3, as the contact point position moves to the lower portion of the interval II in a state in which the load voltage is in the voltage sag state, the degree of the voltage sag increases. When the degree of the voltage sag reaches 100%, V_{d}=VT=−Vₛ. Accordingly, since Vₒ=Vₛ+V_{d} in equation 1, the voltage Vₒ=0. Therefore, the instant outage state occurs.

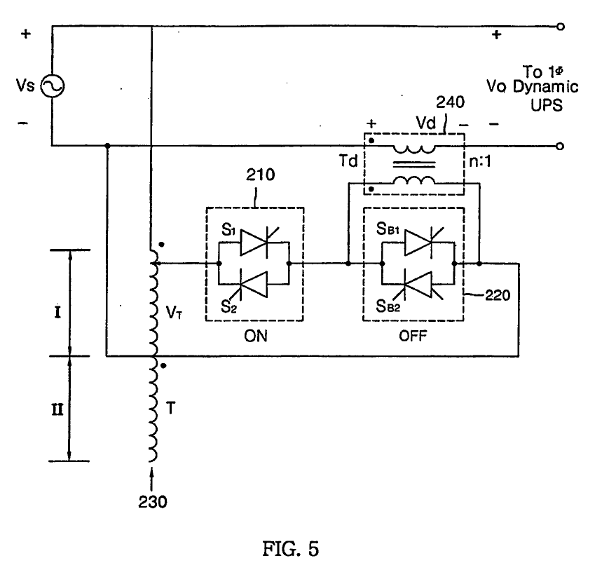

FIG. 5 is a circuit diagram showing the single phase voltage variation generator 200 when the load voltage is in a voltage swell state according to an embodiment of the present invention.

The voltage swell state also occurs when the variable voltage-side switch 210 is turned on and the transformer-side switch 220 is turned off, similarly to the voltage sag state described FIG. 3 or the instant outage state described FIG. 4. Herein, the voltage swell state occurs when the contact point position moves to the interval I. As described in the case of obtaining equation 2, V_{d}=VT/n and VT=Vₛ/nT. When the V_{d} is put into equation 1, Vₒ=Vₛ(1+1/n·nT). Herein, the variable voltage-side switch 210 is connected to the interval I of the variable voltage adjuster 230, the polarity of the voltage V_{d} is positive. Accordingly, equation 3 is obtained.

$${V}_{o} = {V}_{s} ( 1 + \frac{1}{n \cdot {n}_{T}} ) \qquad Equation 3$$

Accordingly, in a state in which the transformation ratio n of the transformer 240 is fixed, the degree of the voltage swell is determined by the transformation ratio nT of the variable voltage adjuster 230. Accordingly, as the contact point position moves to the lower portion of the interval I, the degree of the voltage swell increases.

In the meantime, table 1 shows the switches 210 and 220 and the contact point position for the voltage variation state such as the normal state, the voltage sag state, the instant outage state and the voltage swell state described in FIGS. 2 to 5.

TABLE 1

| | | | contact point |
|---|---|---|---|
| Load voltage (Vₒ) | S1, S2 | SB1, SB2 | position T |
| normal state | OFF | ON | no concern |
| voltage sag state | ON | OFF | upper portion of |
| | | | interval II |
| instant outage | ON | OFF | Lower portion of |
| state | | | interval II |
| voltage swell | ON | OFF | interval I |
| state | | | |

In the meantime, a voltage unbalance state may be described with reference to the voltage variation generator 100 of FIG. 1.

In FIG. 1, the load voltage Vₐₛ, V_{bs} and V_{cs} may be expressed by equation 4 as described in FIG. 3.

$$\begin{matrix}\text{Equation 4} & \\ {V}_{as} = {V}_{a} ( 1 - \frac{1}{n \cdot {n}_{{T}_{a}}} ) & ( 4 \text{-} 1 ) \\ {V}_{bs} = {V}_{b} ( 1 - \frac{1}{n \cdot {n}_{{T}_{b}}} ) & ( 4 \text{-} 2 ) \\ {V}_{cs} = {V}_{c} ( 1 - \frac{1}{n \cdot {n}_{{T}_{c}}} ) & ( 4 \text{-} 3 )\end{matrix}$$

In equation 4, the nTₐ, nT_{b} and nT_{c} mean transformation ratios of the variable voltage adjusters 130, 132 or 134 respectively and the values of the transformation ratios are determined by contact point positions. That is, the nTₐ, nT_{b} and nT_{c} may have the same value or different values. Accordingly, the state and the degree of the voltage unbalance between the load voltage Vₐₛ, V_{bs} and V_{cs} may be easily obtained by differently setting only the contact point position of each of the variable voltage adjusters 130, 132 or 134.

In the meantime, the 3-phase voltage variation generator 100 and the single phase voltage variation generator 200 described in FIGS. 1 to 5 use the SCR thyristor as a switch device. Further, it is possible to use an Insulated Gate Bipolar Transistor (Hereinafter, referred to as IGBT) or an Insulated Gate Command Thyristor (Hereinafter, referred to as IGCT) as the switch device.

Further, in the detailed description of FIGS. 1 to 5, the single or 3-phase dynamic UPS is described as an apparatus for testing the performance of power quality by means of the voltage variation generator according to an embodiment of the present invention. However, the scope of the present invention is not limited to the aforementioned apparatus. That is, the voltage variation generator according to the embodiment of the present invention may be used in the custom power devices such as the aforementioned DVR, DSTATCOM, SVC and SSTS. Further, it is apparent that the voltage variation generator according to the embodiment of the present invention is not limited to the single or 3 phase dynamic UPS described in FIGS. 1 to 5 and may be unlimitedly applicable for use.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

### INDUSTRIAL APPLICABILITY

As described above, the conventional voltage variation generator is not sufficient for wide use because it is very expensive or excessively requires effective power. However, according to the present invention, a voltage variation generator with a low price is constructed by means of a slidacs and an SCR thyristor. Further, its structure is very simple and efficiency is very high. Furthermore, it is possible to manufacture a small/light-weight voltage variation generator.

In addition, according to the present invention, a contact point position of a slidacs is simply adjusted, so that a voltage variation state such as voltage sag, voltage swell and instant outage can be easily generated and the degree of the voltage variation can be easily adjusted. Moreover, it is possible to easily generate a harmonic frequency distortion, notches, etc., by means of a device, such as an IGBT and IGCT, which can control an on/off state.

Further, according to the present invention, a wide range of voltage variation from 0˜100% may occur according to a contact point position of a slidacs and may be simply controlled. Furthermore, the present invention can be effectively applied to not only a small or medium capacity of apparatus but also a large capacity of apparatus more than several tens of Megawatt.

1. A voltage variation generator for generating load voltage of voltage sag, voltage swell and instant outage for performance test of custom power devices, the voltage variation generator comprising:
a supply voltage unit for applying AC supply voltage Vₛ, a positive output terminal of the supply voltage unit being connected in series to a load;
a variable voltage adjuster connected to the positive output terminal of the supply voltage unit, for obtaining first voltage from the supply voltage according to a first transformation ratio;
a variable voltage-side switch including two switching devices connected in reverse-parallel to each other, for selectively contacting in series with a primary side coil (interval I) or a secondary side coil (interval II) of the variable voltage adjuster and adjusting a contact point position with the variable voltage adjuster;
a transformer-side switch including two switching devices connected in series to the variable voltage-side switch, said two switching devices being connected in parallel to each other in a reverse direction; and
a transformer including a primary side and a secondary side, for obtaining second voltage from the first voltage according to a second transformation ratio, the primary side being connected in parallel to the transformer-side switch, the secondary side being connected in series to a negative output terminal of the supply voltage unit and the load respectively.

2. The voltage variation generator as claimed in claim 1, wherein the switching device includes a SCR (Silicon Controlled Rectifier) thyristor.

3. The voltage variation generator as claimed in claim 1, wherein the switching device includes at least one of an Insulated Gate Bipolar Transistor (IGBT) and an Insulated Gate Command Thyristor (IGCT).

4. The voltage variation generator as claimed in claim 1, wherein the variable voltage adjuster is an autotransformer and includes a slidacs.

5. The voltage variation generator as claimed in claim 1, wherein, when voltage across the load is in a normal state, the variable voltage-side switch is turned off, the transformer-side switch is turned on, and the voltage across the load is the same as the supply voltage Vₛ.

6. The voltage variation generator as claimed in claim 1, wherein, when voltage of the load is in a voltage sag state, the variable voltage-side switch is turned on, the transformer-side switch is turned off, the contact point position is located in an upper portion of the secondary side coil, and the voltage across the load is Vₛ(1−1/n·nT).

7. The voltage variation generator as claimed in claim 1, wherein, when voltage across the load is in a voltage swell state, the variable voltage-side switch is turned on, the transformer-side switch is turned off, the contact point position is located in the primary side coil, and the voltage across the load is Vₛ(1+1/n·nT).

8. The voltage variation generator as claimed in claim 6, wherein degree of the voltage sag or voltage swell is adjusted by controlling the first transformation ratio value.

9. The voltage variation generator as claimed in claim 8, wherein the first transformation ratio value is adjusted according to movement of the contact point position while the voltage sag state or the voltage swell state is maintained.

10. The voltage variation generator as claimed in claim 1, wherein, when voltage across the load is in an instant outage state, the variable voltage-side switch is turned on, the transformer-side switch is turned off, the contact point position is located in a lower portion of the secondary side coil.

11. The voltage variation generator as claimed in claim 1, wherein the voltage variation generator is a single phase generator, a 3-phase generator, or a generator having more than 3 phases, wherein the 3-phase generator has at least two contact point positions different from each other, thereby generating a voltage unbalance state.

12. The voltage variation generator as claimed in claim 1, wherein, when voltage of the load is in a voltage unbalance state, the variable voltage-side switch is turned on, the transformer-side switch is turned off, the contact point position is located in an upper portion of the secondary side coil.

13. The voltage variation generator as claimed in claim 1, wherein the load includes at least one of a Dynamic Uninterruptible Power Supply (UPS), a Dynamic Voltage Restorer (DVR), a Distribution Static Compensators (DSTATCOM), a Static Var Compensators (SVC), and a Solid State Transfer Switches (SSTS).
